(19) United States
(12) Patent Application Publication
(10) Pub. No.: US 2009/0106243 A1
(43) Pub. Date: Apr. 23, 2009

(54) SYSTEM FOR OBTAINING OF TRANSCRIPTS OF NON-TEXTUAL MEDIA

(76) Inventor: Bipin Suresh, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/877,609

(22) Filed: Oct. 23, 2007

(51) Int. Cl. G06F 17/30

(52) U.S. Cl. 707/6; 707/102; 707/E17.075; 707/E17.108

(57) ABSTRACT

A system for obtaining textual transcripts of non-textual media is provided. The system uses a voting mechanism to determine which elements within a pool of candidate documents are included within a final transcript that is then associated with the non-textual media.

### FIELD OF THE INVENTION

The present invention relates to a mechanism for associating textual data transcripts with non-textual media, which increases the chances of a user finding the non-textual media.

### BACKGROUND

Consumers sometimes search for non-textual media, including potentially audio media (e.g. sound recordings), visual media (e.g. paintings/drawings), or audio/visual media (e.g. video clips). These consumers can search using textual searches. Examples of text that is associated with audio media include the lyrics of songs, and the words of speeches and presentations. Examples of text that is associated with visual media include a textual description of a painting, or a textual description of a chart from a report.

For the purpose of explanation, text that is associated with a non-textual media item is referred to herein as a “transcript” of the non-textual media item. Thus, as used herein, a non-textual media item does not necessarily contain that words that are present in a transcript of the non-textual media item. For example, a textual explanation of a chart is a transcript of the chart even though the words in the textual explanation may not actually appear on the chart.

The correlation of textual media with non-textual media has traditionally been done by procuring the text from the creators of the non-textual media. For example, a text file containing the words of a song may be obtained from the composers of the song, or from music labels and music studios. In other instances, editors may create a transcript of a non-textual media item by listening to and transcribing the non-textual media item. In still other instances, it is possible to purchase transcriptions of non-text media from third-party sources (such as a record label).

Discovering transcripts corresponding to non-textual media is an important problem for search engines to solve. For example, since a majority of users associate a song with its lyrics, many search engine users search for a song based on the lyrics of the song, rather than the artist/album/song title. Speeches and other audio media are also often remembered by inspirational snippets (‘I have a dream’) rather than formal titles or the events at which the speeches were delivered. Users may choose to search for the non-textual media based on textual terms from such snippets. However, without accurate transcriptions for non-textual media items, prior attempts to search for the non-textual items using textual terms often resulted in false hits in the search results. Consequently, a mechanism for obtaining reliable textual transcripts of non-textual media or events is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an example system for identifying accurate transcripts of non-textual media items; and

FIG. 2 shows a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are described hereafter for (a) obtaining textual transcripts of non-textual media or events, and (b) associating those transcripts with the non-textual media. In one embodiment, search engines are used to identify accurate transcripts of the non-textual media. Once identified, the accurate transcripts are associated with the non-textual media to enable users to search for the non-textual media based on text contained in the transcripts.

In one embodiment, one or more search engines are used to search for existing transcripts of the non-textual media. So search for exiting transcripts of non-textual media, the search engines are queried using textual terms associated with the desired non-textual media. For example, the title and artist of a song may be used as search terms in searches, performed using one or more search engines, to find existing transcripts.

The search engines return results, which preferably include one or more already-existing transcripts (or portions thereof) of the non-textual media. For example, the results of a textual search based on the title and artist of the song preferably include, among other things, one or more already-existing transcripts of the song. The results of the searches are gathered and string-compared using voting criteria to determine sets of strings. The sets of strings are refined to increase accuracy and veracity of content of the transcript. The resulting sets of strings are included in a “virtual transcript” for the non-textual media. While the sets of strings that are selected for inclusion in the virtual transcript come from existing transcripts, the resulting virtual transcript may not actually be identical to any of the existing transcripts.

The virtual transcript is then stored in association with the non-textual media item. For example, the non-textual media item may be indexed based on the terms contained within the virtual transcript that was generated for the non-textual media item. Thereafter, that index may be used by a search engine to allow users to search for the non-textual item using random fragments or snippets from the transcript of the non-textual item.

### Explanation of System

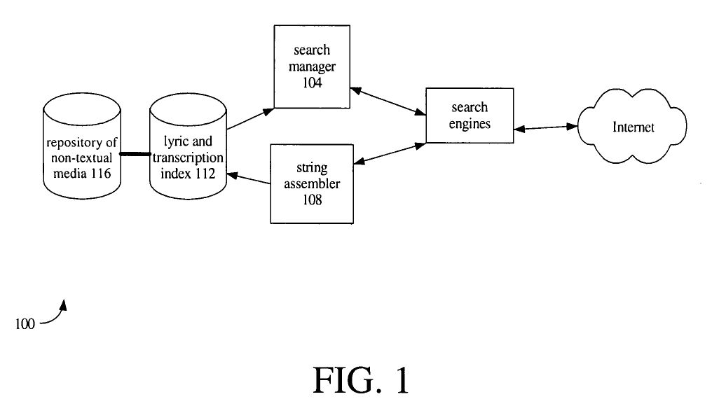

A system 100 for obtaining transcripts is shown in FIG. 1. Within the system 100, a search manager 104 works in conjunction with a string assembler 108 in basically two steps. First, the search manager 104 performs an amalgamated search and develops a pool of candidate documents. Second, the search manager 104 forwards these candidate documents to the string assembler 108, which digests the pool of candidate documents into a set of text strings (the “virtual transcript”) that is then associated with a specific non textual media.

As shown in FIG. 1, a repository 116 of non-textual media is shown. The repository 116 is designed to be searchable by users. To allow a user to search repository 116 based on textual terms contained in transcripts, the transcripts must be identified/generated and the non-textual media must be indexed based on the textual terms from the transcripts. Techniques for generating virtual transcripts, and for using the virtual transcripts to answer searches for non-textual media, shall be described in greater detail hereafter.

### Discovering Potential Pre-Existing Transcripts

To generate a virtual transcript for a non-textual media item, a search manager 104 formulates a query to search for existing transcripts. To formulate the query, the search manager 104 may take advantage of metadata that often accompanies non-textual media. This metadata can include the title of a DVD, CD, album, or other collective work that contains the non-textual media, data that indicates an artist's name associated with the non-textual media, data that identifies a date and time of event associated with the non-textual media; or one or more keywords associated with the non-textual media.

In one embodiment, the search manager 104 sends the query to a variety of search engines 110 to discover existing transcripts for the non-textual media items. The search engines 110 are in communication with a content-based computer network, such as but not limited to the Internet. In response to submitting the query to the search engines 110, the search manager 104 obtains the top documents that satisfy a query. Those top documents are potential pre-existing transcripts.

### Filtering the Potential Pre-Existing Transcripts

While some of the documents in the search results produced by the search engines 110 may be pre-existing transcripts of the non-textual media item, the search results may also include many other documents that are not transcripts. Therefore, in one embodiment, search manager 104 filters the top documents to exclude those documents that are not likely to be transcripts of the non-textual media item.

According to one embodiment, the search manager 104 receives the search results in descending order of relevance to the query, i.e. top-ranked results are more relevant than the bottom-ranked ones.

Some search engines also provide a feature to sort their results by criteria other than relevance (e.g. date of publication). Within the system 100, such a feature is not desired. Accordingly, the search manager 104 ensures that the sorting criteria used in forming the candidate pool is limited to relevance and nothing else. Search results with a relevance below a predetermined threshold are not retained.

Another feature of the search manager 104 is to only forward candidate documents to the string assembler 108 that exceed a minimum size. This is because extremely short documents are less likely to contain the requested transcripts. Documents below a minimum threshold size are discarded and not included in the candidate pool. Additionally, the search manager 104 removes any documents retrieved from sites suspected of being spammy. Such spam information can be obtained and updated through prior knowledge or published lists.

Search manager 104 then establishes the top documents from the search results as a document pool used to generate a virtual transcript. Specifically, the document pool is used to seed the string assembler 108.

### Generating the Virtual Transcript

After receiving a pool of candidate documents, the string assembler 108 then reviews the various documents within the candidate pool, each of which may contain overlapping subsets of the actual transcripts. However, any one of these documents can be amateur efforts, may have typographical errors, missing or erroneous sub-sections, or material that is irrelevant. Thus, further processing is needed.

### Common Substring Algorithm

Because the various pre-existing transcripts can have errors, the string assembler 108 implements a common substring algorithm by identifying the longest common substrings from the document pool. The running time of the string assembler 108 is proportional to the lengths of the source web-pages in the candidate pool.

The concept of longest common substring is explained as follows. Suppose three text strings exist: ABABC, BCEF, and ABCDEF. The longest common substring among these text strings would be BC. However, supposing the text string BCEF was found to be erroneous or irrelevant as described above, the longest common substring would then be ABC.

The string assembler 108 performs additional processing on the set of strings, which may or may not include setting up a generalized suffix-tree data structure for the substrings, and then finding and storing the deepest internal nodes within that tree. The string assembler 108 applies numerous algorithms for determining the longest common substrings from a group of textual documents. The result is a set of raw substrings. The set of raw substrings may then be used as the virtual transcript of the non-textual item.

### Voting Mechanism

Unfortunately, the raw substrings produced by the common substring algorithm may not be a very accurate transcription of the non-textual media item. To increase the accuracy of the resulting transcript, in one embodiment, the string assembler 108 implements a voting mechanism, wherein a line from the candidate pool will be included in the final virtual transcript only if more than a predefined percentage of candidates have that line. Using a voting mechanism in this manner will also have the effect of eliminating noise and artifacts, since such aberrant elements will not be commonly held across multiple documents.

The string assembler 108 compares the various documents by parsing the documents line-by-line, and in doing so delineates ‘lines’ by using punctions (e.g. periods, semicolons etc.) and HTML separators (like the <br/> tag).

If, for example 75% of the candidates in the pool agree on a certain substring of text, the string assembler 108 includes that substring in the virtual transcript associated with the non-textual media. Otherwise, the substring is excised. If only 1 of 15 documents actually has the lyrics of a song, no lines will satisfy the 75% voting threshold. In situations where few lines, or no lines, satisfy the voting threshold, the string assembler 108 can, for example, (a) broaden the search criteria used by search engines 110, thereby increasing the candidate pool. The string assembler 108 may also lower the voting threshold that must be satisfied for a line to be included in the virtual transcript. The end result is that the system returns a virtual transcript in the form of a set of text strings.

Once the virtual transcript for a media item is generated, the virtual transcript may be stored in index 112 and used to search for non-textual items based on text contained in the virtual transcript. The system 100 is flexible enough to provide useful information for a search based on a fragment of lyrics only, without knowing the artist.

According to another embodiment, the virtual transcripts may be used in a variety of ways. For example, the virtual transcripts may be stored and indexed as actual documents, so that textual searches based on lyrics of a song will produce search results that include the virtual transcription, as well as pre-existing transcriptions.

In one embodiment, the search manager 104 and string assembler 108 operate automatically, so that no human intervention is necessary.

### Example Use of System

Suppose the system 100 has an audio recording of Martin Luther King's “I had a dream” speech. To an accurate transcript therewith, the search manager 104 passes the text phrase “Martin Luther King, I had a dream” to the search engines, which then return a set of search results.

Now suppose for example that 14 documents were found within the search results. The search manager 104 forwards these 14 documents (the candidate pool) to the string assembler 108, which parses the 14 candidate documents line-by-line and then applies various tunable voting criteria to determine which lines to include in the virtual transcript. Each line within each of the 14 documents in the candidate pool will be compared, where those lines are subject to voting criteria. If a line survives the voting process, then that line is included in a set of strings or final transcript within the lyric and transcription index 112. This final transcript is then associated with a specific non-textual file in the repository 116.

### Hardware Overview

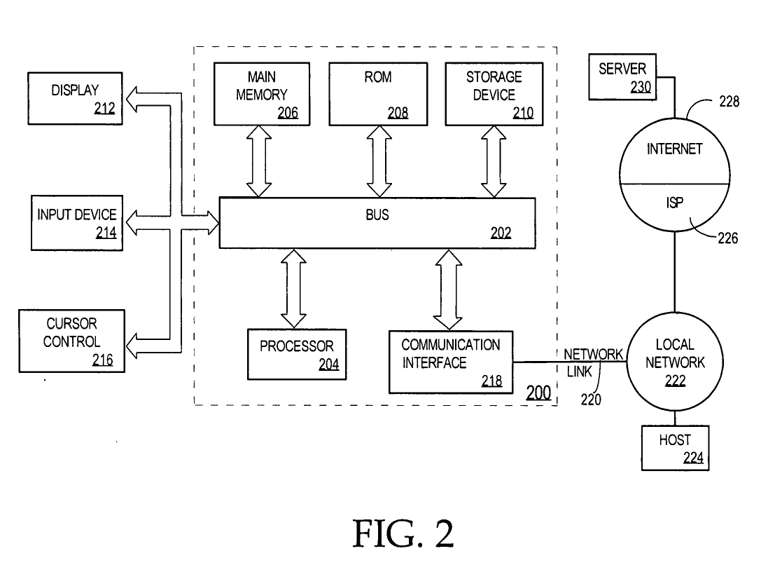

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operation in a specific fashion. In an embodiment implemented using computer system 200, various computer-readable media are involved, for example, in providing instructions to processor 204 for execution. Such a medium may take many forms, including but not limited to storage media and transmission media. Storage media includes both non-volatile media and volatile media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a computer.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218. The received code may be executed by processor 204 as {avoid pronouns} it is received, and/or stored in storage device 210, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for automatically determining accurate transcripts for non-textual media, comprising:
identifying a pool of candidate documents containing textual data representing content of a non-textual media item;
processing the pool of candidate documents according to a set of conditions;
identifying a set of substrings within the pool of documents that satisfy the conditions; and
storing, in a computer-readable storage medium, data that establishes the set of substrings that satisfy the conditions as a virtual transcript for the non-textual media item.

2. The method of claim 1, further comprising associating the virtual transcript with the non-textual media item.

3. The method of claim 2, further comprising:
receiving a text query;
in response to the text query, comparing the query against the virtual transcript; and
in response to determining a match between the query and the virtual transcript,
providing search results that include the non-textual media item.

4. The method of claim 1, wherein the step of identifying a pool is based on metadata associated with the non-textual media item.

5. The method of claim 4, wherein the metadata comprises at least one of the title of the particular non-textual media, title of CD that contains the non-textual media, data that indicates an artist name associated with the non-textual media, data that identifies an event date and time of event associated with the non-textual media; or one or more keywords associated with the non-textual media.

6. The method of claim 1, wherein the step of identifying a pool of documents comprises:
submitting to one or more search engines, one or more queries that contain terms relating to the non-textual media item; and
identifying the pool of documents based at least in part on search results produced by the one or more search engines based on the one or more queries.

7. The method of claim 1, wherein the step of submitting to one or more search engines further comprises submitting the one or more queries to each of a the one or more search engines.

8. The method of claim 7, wherein the step of identifying a pool of documents includes identifying a pool of documents produced by each of the plurality of search engines.

9. The method of claim 1, wherein the step of identifying a pool of documents includes identifying documents from one or more repositories known to include text associated with the non-textual media items.

10. The method of claim 1, wherein the step of identifying the set of substrings comprises applying a least common substring (LCS) algorithm to the pool of documents.

11. The method of claim 2, wherein the step of associating the virtual transcript with the non-textual media item comprises storing an association between the virtual transcript and the non-textual media item within an index that is built on a collection of non-textual media objects.

12. The method of claim 11, further comprising:
receiving a query that searches for non-textual media using textual items; and
comparing the query with the index.

13. The method of claim 1, wherein the non-textual item is an audio recording.

14. The method of claim 13, wherein non-textual item is an audio recording of a song, and the set of substrings include lyrics of the song.

15. The method of claim 1 wherein the non-textual item is an audio recording of a speech, and the set of substrings include words of the speech.

16. A system for associating non-textual media with text that represents content of the non-textual media, comprising:
a repository of non-textual media;
a search mechanism for gathering documents found using textual input and locating those documents in a candidate pool; and
a string assembler for performing a comparison of the candidate documents within the candidate pool and outputting a set of strings as a virtual transcript stored on a computer-readable storage medium.

17. The system of claim 16, wherein the textual input can be song title, CD title, artist name, event, transcript/lyric or other keywords.

18. The system of claim 16, wherein the search mechanism sorts the candidate pool in descending order of relevance to the textual input.

19. The system of claim 16, wherein the search mechanism requires a minimum size of a candidate document.

20. The system of claim 16, wherein the string assembler uses a suffix-tree data-structure to implement a common substring algorithm by identifying common substrings from the document pool.

21. The system of claim 16, wherein the string assembler implements a voting mechanism on the candidate pool.

22. The system of claim 21, wherein the voting mechanism stipulates that a phrase or sentence component will be included in the final set of strings delivered through the user interface only if more than a predefined percentage of pages have that component.

23. A computer-implemented method for automatically determining accurate transcripts for non-textual media, comprising:
means for identifying a pool of candidate documents containing textual data representing content of a non-textual media item or event;
means for processing the pool of candidate documents according to a set of conditions; and
means for identifying a set of substrings within the pool of documents that satisfy the conditions.

24. A computer-readable storage medium storing one or more sequences of instructions which, when executed by one or more processors, causes the one or more processors to perform the following steps, comprising:
identifying a pool of candidate documents containing textual data representing content of a non-textual media item or event;
processing the pool of candidate documents according to a set of conditions; and
identifying a set of substrings within the pool of documents that satisfy the conditions.
